(19) United States
(12) Patent Application Publication
(10) Pub. No.: US 2006/0021150 A1
(43) Pub. Date: Feb. 2, 2006

(54) Durable treatment for fabrics

(76) Inventors: Cheng Hu, Oakland, CA (US); David A. Offord, Castro Valley, CA (US); William Ware JR., Redwood City, CA (US)

Correspondence Address: MORRISON & FOERSTER LLP, 755 PAGE MILL RD, PALO ALTO, CA, 94304-1018, US

(21) Appl. No.: 11/191,442

(22) Filed: Jul. 27, 2005

Related U.S. Application Data
(60) Provisional application No. 60/591,296, filed on Jul. 27, 2004.
(60) Provisional application No. 60/624,875, filed on Nov. 3, 2004.

(51) Int. Cl. C11D 3/00

(52) U.S. Cl. 8/115.51

(57) ABSTRACT

Compositions for imparting a performance enhancing property to a fabric comprising a complex between an anionic polymer and a cationic polymer, wherein either the anionic polymer or the cationic polymer comprises a functional group that is capable of imparting the performance enhancing property to the fabric are disclosed. The performance enhancing properties are durable and can withstand many home launderings. In addition, methods for applying polyelectrolytes complexes to fabrics to impart a persistent performance enhancing property to the fabric are disclosed. Fabrics having durable performance enhancing coatings are described, where the coatings are formed from polyelectrolytes.

### CROSS REFERENCE TO RELATED APPLICATIONS

This application claims priority to U.S. Ser. No. 60/591,296 filed on Jul. 27, 2004 and to U.S. Ser. No. 60/624,875 filed on Nov. 3, 2004, both of which are herby incorporated by reference in their entirety.

### FIELD

The compositions and methods described herein are in the field of performance-enhancing treatments for fabrics, more specifically to durable coating compositions and methods of applying such coatings to fabrics, including fibers, non-wovens, leathers, films, and plastics. The treated fabrics are particularly useful in non-industrial applications, such as garments, footwear, draperies, curtains, bedding, upholstery, outdoor fabrics (e.g., for umbrellas, awnings, tents, and the like), carpets and rugs. The treated fabrics may also be useful in automobile interiors and technical textiles.

### BACKGROUND

It is often desired to impart performance enhancing characteristics to fibers and fabrics by applying surface coatings. Examples of such characteristics include antistatic properties, stain resistant properties, soil release properties, repellency or resistance, e.g., for oil or water, moisture wicking properties, antimicrobial properties, and flame retardancy. However, such performance enhancing coatings are typically not durable. That is, they lose their effectiveness after laundering, cleaning, or exposure to water, oil or contaminants, or by mechanical stress (e.g., by stretching or abrasion).

Methods have been developed for making textile materials water repellent. Water repellent fabrics generally have open pores and are permeable to air and water vapor. Commercial processes for manufacturing water repellent fabrics are based on lamination processes and polysiloxane coatings. One lamination process involves adhering a layer of polymeric material, such as TEFLON® fluoropolymer, that has been stretched to produce micropores, to a fabric. Although this process can produce durable water repellent films, it has the disadvantages of being costly, requiring special manufacturing equipment, and other problems due to mismatching or shrinkage between the fabric and polymeric film. Polysiloxane coatings have low durability with respect to home laundering.

Fabrics (e.g., cotton) have been given hydrophobic characteristics by using hydrophobic polymer films or monomers attached using physi-sorptive or chemi-sorptive processes. Water repellents using monomeric hydrocarbon hydrophibic groups that have been used for this purpose include aluminum and zirconium soaps, waxes, QUILON® chrome metal complexes, pyridinium compounds, methylol compounds, and other fiber reactive water repellents. However, soaps and waxes that are non-covalently attached to fabrics do not form robust coatings and degrade upon washing or dry cleaning. QUILON® chrome complexes have also been used, because they can polymerize to form Cr—O—Cr linkages and can form covalent bonds with the surface of fibers to form a water repellent semi-durable coating. However, QUILON® complexes require acidic conditions to react, which can degrade the fiber through cellulose hydrolysis. Other methods require strong acidic or basic conditions or long, high temperature curing times that can damage the fabric or fibers, thus limiting their applications. Still other methods involve toxic components or by-products.

The treatment of fibrous substrates with fluorochemical compositions to impart water and oil repellent properties is known. Generally copolymers are used which comprise a (meth)acrylate monomer containing a perfluoroalkyl group capable of directly imparting water- and oil-repellence, a fluorine-free monomer capable of adhering to the surfaces of materials to be treated, and a monomer capable of giving durability through self-crosslinking or reacting with reactive groups on the surface of the materials to be treated. Typical copolymers are copolymers that have N-methylol groups combined with the main chain, such as copolymers of perfluoroalkyl group-containing (meth)acrylate and N-methylol acrylamide-based copolymers.

Insoluble metal complexes have been used to permanently attach fluorinated compounds to a textile to impart oil- and water-repellency and soil resistance to the textile. However, these methods can require the use of solvents such as isopropanol and carbon tetrachloride, which are disfavored for economic and environmental reasons. Other methods involve the use of water-soluble fluoropolymer/metal complexes that allow the fluorinated complex to be precipitated onto a substrate surface; however, durability is low due to weak binding with the substrate. Another method involves the use of block copolymers composed of acid-containing monomers capable of binding to wool or other fibrous substrates with metal and fluorinated monomers. Such methods are described in U.S. Pat. No. 6,855,772, which is hereby incorporated by reference.

It is also known to use a fluoropolymer together with a tacking polymer prepared from a monomer, oligomer or polymer having an anhydride functional group or a functional group capable of forming an aldehyde functional group to impart water- and oil-repellency to fibrous substrates. Examples of such systems are described in U.S. Pat. No. 6,472,476, which is hereby incorporated by reference. Therein, it was thought that reactive groups on the tacking polymer react with the fibrous material by covalent bonding during a curing step.

It has been described in U.S. Pat. Nos. 6,617,267 and 6,379,753, which are hereby incorporated by reference, to coat substrates having functional groups such as thiol, amine, hydroxyl, and carboxylic acid groups with multifunctional polymers that include binding functional groups that are capable of covalently bonding with the substrate or associating with the substrate via hydrogen bonds, van der Waals interactions, ionic, or other non-covalent interactions between the substrate and the multifunctional polymers. The multifunctional polymers can comprise hydrophobic, hydrophilic, or oleophobic groups. The coated substrates have improved properties such as water resistance, water repellency, oil repellency, permanent press properties, and quickness of drying. The multifunctional polymers can comprise hydrophobic regions and hydrophilic regions, so that upon coating the polymers can adopt a configuration in which the hydrophilic region can attach either covalently or non-covalently with the substrate, and the hydrophobic regions orient away from the substrate, providing hydrophobic properties to the coated substrate.

Polyelectrolytes are high molecular weight ionic polymers whose solutions are highly electrically conductive. Polyelectrolyte complexes can be formed by combining solutions of oppositely charged polyelectrolytes. The oppositely charged polymers form relatively insoluble complexes due to electrostatic interactions between the polyelectrolytes. In addition, thin polymeric films created by layer-by-layer (LbL) deposition of polyelectrolyte layers have been used to modify the surface properties of materials. During LbL film growth, a charged substrate is dipped back and forth between solutions of positively and negatively charged polyelectrolytes, with a washing step in between each dipping step. During each dipping step, polyelectrolyte is adsorbed onto the surface and the surface charge is thereby reversed, allowing the build-up of polycation-polyanion layers. The polyelectrolyte layers are capable of self-organization, where the driving force behind layer build-up involves electrostatic interactions between the oppositely charged layers. Using electrostatic interactions to form multiple layers can be particularly advantageous because electrostatic interactions do not have the same steric limitations as chemical bonds. Such processes are described for example, in Decher, Science, vol. 277, Aug. 29, 1997, 1232-1237, and U.S. Pat. No.5,208,111, which are hereby incorporated by reference. Advantages of LbL coatings include their ability to conformably coat objects and their use of water-based processing. Polyelectrolytes can function as filtration barriers, with tunable permeability for gases, liquids, molecules and ions, e.g., as filtration membranes for ion exchange. In addition polyelectroytes have been used for battery electrodes, for anticorrosion coatings for metal objects, for thin optical coatings, and for antistatic coatings for electronic applications.

Synthetic polymeric fibers and fabrics have a tendency to retain static electrical charge for long periods of time. Electrostatic build-up can occur rapidly and dissipation of the charge can be extremely slow (many hours or longer). This property can cause handling problems during manufacturing, wearer discomfort for garments, and electrical shocks from garments and carpets and the like. In addition, electrically charged materials may attract dust, dirt and lint. Therefore, electrically charged synthetic fabrics and fibers can benefit from dissipation of static charge.

Numerous methods have been proposed to dissipate electrostatic charge on fabrics. Examples of such methods include the application of an antistatic agent onto the surfaces of fabrics. Antistatic agents cover a broad range of chemical classes, including organic amines and amides, esters of fatty acids, organic acids, polyoxyethylene derivatives, polyhydridic alcohols, metals, carbon black, semiconductors, and various organic and inorganic salts. Many are also surfactants and can be neutral or ionic. Such agents, however, have proven to lack durability because of their solubility in water. Antistatic properties are typically lost during washing, cleaning or by mechanical damage. It has also been proposed that an antistatic agent be incorporated directly into a polymeric substrate during its formation, while at the same time attempting to maintain the fiber's spinnability and quality of construction.

The accumulation of static charges and the slow dissipation thereof on synthetic fibers can prevent finished, polymeric fabrics from draping or wearing in a desirable manner. Fibers having a high electrostatic susceptibility often cling to guides and rolls in textile machinery during manufacturing and processing and can be damaged and weakened as a result, lowering yield or quality of the end product. For these reasons, and because end-uses for fabrics such as garments, upholstery, hosiery, rugs, bedding, curtains and draperies can benefit by a reduced tendency to accumulate and maintain electrostatic charges, a permanent antistatic composition to be applied thereon is needed.

Presently, in the commercial production of synthetic polymeric fibers, the as-spun filaments are typically given some treatment to improve their electrostatic and handling properties. This treatment usually consists of passing the filaments while in the form of a bundle through a bath or over a wheel coated with a treating of finishing liquid. The finish thus applied is a coating and is not of a permanent nature. Most, if not all, of the antistatic agent on the fiber surface is lost in subsequent processing of the filament by mechanical handling, heating, washing, scouring and dyeing. If the antistatic agent does remain on the fiber until the final end product is produced, it often becomes less effective after the end product is used for a period of time, and especially after a number of washings or dry cleaning operations.

Efforts have been made in the past to produce permanent antistatic polymeric fibers and articles by the application of a more permanent coating. However, due to harsh finishing applications, the coatings would either be removed and/or fail to perform adequately. Attempts have also been made to incorporate antistatic type co-monomers directly into the base polymeric materials. These methods have proven unsuccessful for various reasons, such as a resultant harsh fiber surface or sacrifice of desired fiber physical properties.

Another way to achieve a durable antistatic material is to weave conductive fibers into synthetic textiles. However, the fibers tend to show as streaks through the fabric, which is not desirable. Additionally, fibers can break, thus losing their conductivity, and conductive fibers can have much higher cost than antistatic finishing.

Antistatic compositions are also used for enhancing the receptivity of plastic surfaces to electrostatically applied coatings, e.g., in automobile production. In this application it is also desirable that the antistatic composition resists removal when exposed to an aqueous rinse or wash liquid.

Thus, there is a need for methods and compositions for modifying various fabrics to alter and optimize their properties for use in different applications. In particular, there is a need for methods and compositions for durably improving the performance properties, including but not limited to antistatic behavior, oil and water repellency, oil and water resistance, hydrophobicity, hydrophilicity, flame retardancy, soil resistance, antimicrobial behavior, flame retardancy, speed of drying, wrinkle recovery, thermal regulation, and UV resistance, of various fabrics containing natural, man-made, and/or synthetic materials or fibers.

### SUMMARY

Described herein are compositions for producing durable performance-enhancing coatings for fabrics and methods for applying durable performance-enhancing coatings to fabrics. In general, the treated fabrics described herein are useful in non-industrial applications, such as wearable garments and footwear, curtains, draperies, bedding, upholstery, outdoor fabrics (such as umbrellas, awnings, tents and the like), carpets and rugs. The treated fabrics may also be useful in automotive interiors and technical textiles.

“Fabrics” include synthetic, man-made and natural fibers or combinations or blends thereof, including finished goods, yams, cloth, and may be woven or non-woven, knitted, tufted, stitch-bonded, or the like. Fabrics also include leathers, non-wovens, plastics, films, and the like. Included in the fabrics may be non-fibrous components such as particulate fillers, binders and sizes. Synthetic fibers or fabrics can comprise synthetic fibers in the form of continuous or discontinuous monofilaments, multifilaments, staple fibers, and yarns containing such filaments and/or fibers, which can be of any desired composition. Examples of natural fibers and fabrics include cotton, wool, silk, jute, and linen. Examples of man-made fibers and fabrics include regenerated cellulose, rayon, cellulose acetate, and regenerated proteins. Examples of synthetic fibers include polyesters (e.g., polyethyleneterephthalate and polypropyleneterephthalate), polyamides (e.g., nylon), acrylics, olefins, aramids, azlons, modacrylics, novoloids, nytrils, aramids, spandex, vinyl polymers and copolymers, vinal, vinyon, vinylon, Nomex® polymer (DuPont) and Keviar® polymer (DuPont).

“Performance-enhancing” properties or characteristics of fibers or fabrics include but are not limited to antistatic behavior, water- and/or oil-repellence, water- and/or oil-resistance, hydrophobicity, hydrophilicity, stain resistance, soil release behavior, moisture wicking, wrinkle resistance, wrinkle recovery, antimicrobial, flame retardancy, thermal regulation, ultraviolet (UV) resistance, and any combinations thereof.

Durable performance-enhancing properties refer to properties or characteristics of a fabric that persist after cleaning, e.g., after at least about 10 home launderings of the fabric, or after at least about 25 home launderings, or after at least 30 home launderings, or after at least about 40 home launderings, or after at least about 50 home launderings. Although the performance enhancing properties may change from an initial level after cleaning, e.g., home laundering, they persist, i.e., remain above a minimum acceptable level, after a specified number of home launderings, industrial launderings, dry cleanings, or any other method of cleaning, such as steam cleaning of carpets.

In one aspect, a composition for imparting a performance enhancing property to a fabric is provided, wherein the composition includes a complex between an anionic polymer and a cationic polymer. Either the anionic polymer or the cationic polymer has a functional group that is capable of imparting the performance enhancing property to the fabric. In some variations, the complex is formed by first attaching one of the anionic polymer and the cationic polymer to at least a portion of a surface of the fabric and subsequently applying the other of the anionic polymer and the cationic polymer to the fabric. The last to be applied of the anionic polymer and the cationic polymer comprises the functional group. In some variations, the complex is formed by first combining the cationic polymer and the anionic polymer in solution. In some variations, the cationic polymer and the anionic polymer each have a charge density greater than 1 meq/g.

In another aspect, a method of treating a fabric is provided. The method comprises modifying a surface of the fabric by providing ions or ionizable compounds having a first charge on at least a portion of the surface. A first ionic polymer having an opposite charge to the first charge is applied to the fabric. The first ionic polymer has a functional group capable of imparting a performance enhancing property to the fabric. In some variations, the modification of the surface of the fabric comprises applying a second ionic polymer having the first charge to the fabric. In other variations, the first ionic polymer has a charge density greater than 1 meq/g. In still other variations, both the first ionic polymer and the second ionic polymer have charge densities greater than 1 meq/g.

In another embodiment, a method for treating a fabric is provided, the method including applying a complex between a cationic polymer and an anionic polymer to a surface of the fabric. One of the cationic polymer and the anionic polymer includes a functional group capable of imparting a performance enhancing property to the fabric.

In another aspect, a fabric having a performance enhancing property is provided. The performance enhancing property is selected from the group including but not limited to water repellency, oil repellency, stain resistance, antistatic behavior, soil release behavior, wrinkle resistance, hydrophobicity, hydrophilicity, antimicrobial behavior, flame retardancy, thermal regulation, UV resistance, and combinations of two or more thereof. A coating is disposed on at least a portion of the fabric, the coating comprising an ionic polymer having a functional group that is capable of imparting the performance enhancing property to the fabric. In some variations, the coating includes a complex between a cationic polymer and an anionic polymer, wherein one of the cationic polymer and the anionic polymer includes the functional group. In some variations, the ionic polymer has a charge density of greater than 1 meq/g. In other variations, both the cationic polymer and the anionic polymer have charge densities greater than 1 meq/g. In some variations, the performance enhancing property persists after 25 home launderings of the fabric. In other variations, the performance enhancing property persists after 50 home launderings of the fabric.

Kits for treating fabrics are also provided. In some variations, the kits comprise an anionic polymer and a cationic polymer, wherein either the anionic polymer or the cationic polymer comprises a functional group that is capable of imparting a performance enhancing property to the fabric. The kits also provide instructions for applying the polymers to the fabric.

It is contemplated that any combination of methods and compositions may be used to produce the fabrics disclosed herein.

### BRIEF DESCRIPTION OF THE DRAWINGS

FIG. 1 provides a schematic of the process of layer-by-layer build-up of a polymer film using polyelectrolytes.

FIG. 2 provides a schematic of a variation of a method for modifying the properties of a fabric using a polyelectrolyte complex. In this illustration, the complex is formed by adsorbing a first polyelectrolyte from solution onto the fabric, washing, and then adsorbing a second polyelectrolyte onto the fabric, and washing and drying. The second polyelectrolyte contains one or more functional groups capable of imparting one or more performance enhancing properties to the fabric.

FIG. 3 provides a cross-sectional schematic of a fabric that has been treated by attaching a functionalized polyelectrolyte complex to a surface of the fabric.

FIG. 4 provides a schematic of a variation of a method for modifying the properties of a fabric using a polyelectrolyte complex. In this illustration, the surface of the fabric is charged, and a functionalized polyelectrolyte having the opposite charge is adsorbed onto the fabric. The functionalized polyelectrolyte has functional groups that are capable of imparting a performance enhancing property to the fabric.

FIG. 5 provides a cross-sectional schematic of a fabric that has been treated by attaching a functionalized polyelectrolyte to a charged fabric surface.

FIG. 6 provides a schematic of a method for modifying the properties of a fabric using a polyelectrolyte complex. In this illustration, a complex between two oppositely charged polyelectrolytes is prepared in solution before application to the fabric. The complex is then applied to the fabric from solution. At least one of the polyelectrolytes has functional groups selected to impart a performance enhancing property to the fabric.

### DETAILED DESCRIPTION

Methods and compositions for modifying fabrics, as well as treated fabrics are provided. Using the methods and compositions described here, a variety of fabrics can be modified to impart selected performance enhancing properties to the fabric.

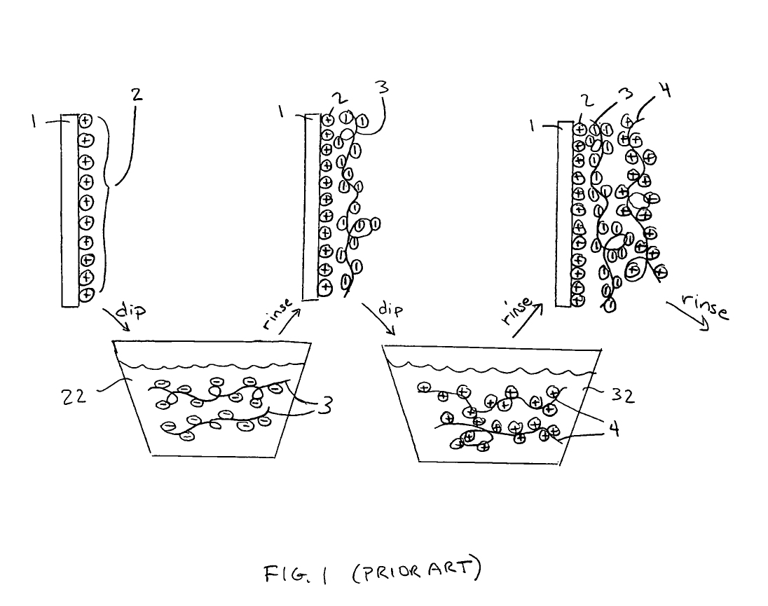

FIG. 1 shows a schematic of the known LbL process of building up a polymer film on a surface. First, a substrate 1 having a charged surface is provided. For purposes of illustration only, the charges 2 have been depicted as positive charges. The substrate is dipped into an aqueous solution of an ionic polymer having a charge opposite to that of the surface. In this illustration, charged substrate 1 is dipped into aqueous solution 22 of anionic polymer 3. The coated substrate is then rinsed. The anionic polymer 3 aligns with and adsorbs onto the charged substrate 1 via electrostatic interactions between the positively charged surface and the negatively charged polyion 3. The substrate having the anionic polymer adsorbed onto it is then rinsed, and dipped into aqueous solution 32 of a cationic polymer 4. The twice-coated substrate is then rinsed. The cationic polymer 4 aligns itself with and adsorbs onto the anionic polymer 3 via electrostatic interactions between the two ionic polymers. The film can be built up in such a manner with many layers. In some cases, the conformation (e.g., elongation) of the ionic polymers can be controlled by varying the concentration of counterions in the aqueous solutions.

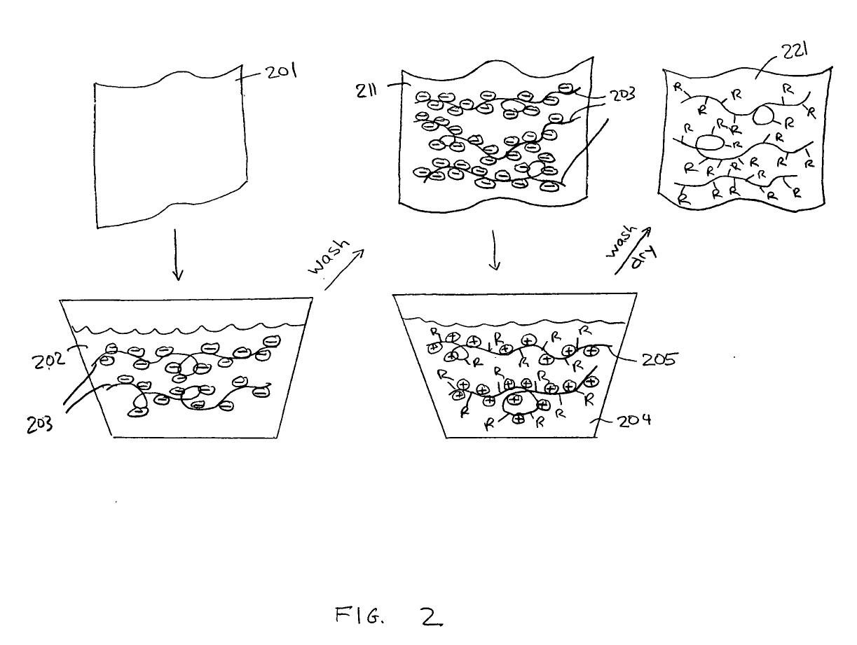

FIG. 2 shows a schematic illustration of one variation of a method for treating a fabric described herein. The fabric 201 is contacted with an aqueous solution 202 of a first polyelectrolyte 203, e.g., by dipping, exhausting in a dyeing machine, or any other suitable process. Although polyelectrolyte 203 is depicted as being anionic for purposes of illustration, polyelectrolyte 203 can be either negatively or positively charged. The fabric is subsequently washed to result in fabric 211 having a charged surface due to the first polyelectrolyte 203 adsorbed thereon. The fabric 211 is then contacted with solution 204 of a second polyelectrolyte 205 oppositely charged from the first polyelectrolyte and having functional groups R. The second polyelectrolyte 205 adsorbs onto the charged surface of fabric 211 and attaches to the surface at least in part by virtue of the electrostatic interactions between oppositely charged polyelectrolytes 203 and 205. The fabric is subsequently washed and dried to result in treated fabric 221. Alternatively, polyelectrolyte 203 can be applied to fabric 201 under conditions which allow it to covalently bond to fabric 201, e.g., by including a curing step after dipping fabric 201 into solution 202 and rinsing. Outermost (i.e., last applied) polyelectrolyte 205 can have more than one type of functional group. In addition, both polyelectrolytes 203 and 205 can have functional groups. The functional groups on the outermost polyelectrolyte 205 are capable of imparting a performance enhancing property to the fabric. Optionally, multiple polyelectrolyte layers can be built up before application of the outermost functionalized polyelectrolyte 205. Polyelectrolytes 203 and 205 form a stable polyelectrolyte complex that is insoluble in water, thereby providing a coating to the fabric which is durable to water-based cleaning conditions, e.g., home laundering, industrial laundering, or steam cleaning. In some variations, the stable polyelectrolyte complex formed from polyelectrolytes 203 and 205 is insoluble in most organic solvents, thereby providing a coating to the fabric which is durable to solvent-based cleaning conditions, e.g., dry cleaning.

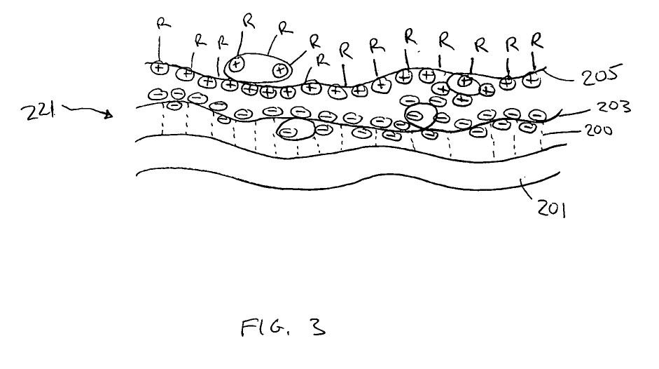

FIG. 3 shows a cross-sectional schematic of the treated fabric 221. The first polyelectrolyte 203 is attached to fabric 201, indicated by dotted lines 200. Dotted lines 200 can indicate non-covalent interactions, e.g., hydrogen bonding or van der Waals interactions. Alternatively, the first polyelectrolyte 203 can be covalently bonded to fabric 201. The second functionalized polyelectrolyte 205 having opposite charge to the first polyelectrolyte 203 is adsorbed onto and attached to fabric 211 at least in part by virtue of the electrostatic interactions between polyelectrolytes 203 and 205. The polyelectrolytes 203 and 205 form a stable polyelectrolyte complex which has low solubility in water. The functional groups R, which can comprise more than one type of functional group, originate from outermost polyelectrolyte 205 and are capable of imparting performance enhancing properties to the treated fabric 221. In a typical variation, polyelectrolyte 205 is oriented such that the functional groups R of polyelectrolyte 5 extend from the surface of the fabric, whereas the charged portions of polyelectrolyte 205 align with and attach to oppositely charged polyelectrolyte 203. The functional groups R can be chosen to impart the desired properties to the fabric, e.g., the R groups can comprise fluorocarbon groups or both fluorocarbon groups and hydrocarbon chains that render the fabric oleophobic, hydrophobic, and stain resistant.

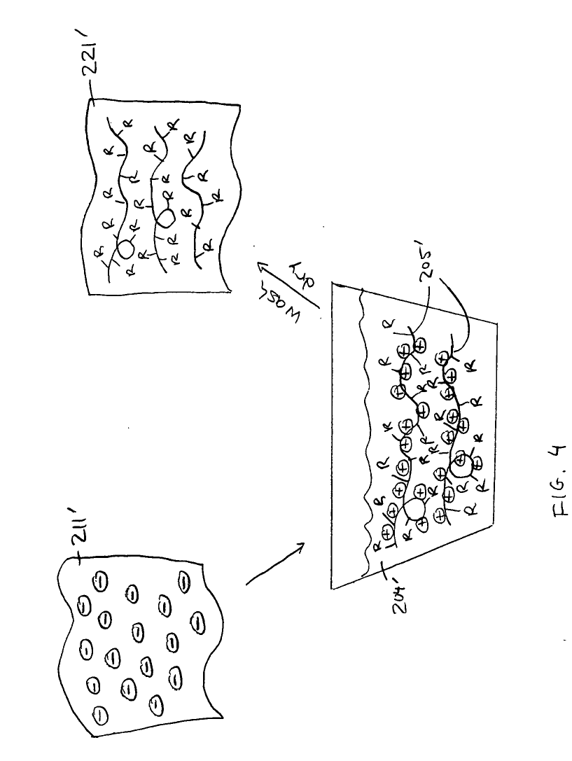

FIG. 4 shows a schematic of another variation of a method for treating a fabric described herein. Fabric 211′ having a charged surface is contacted with solution 204′ of polyelectrolyte 205′ having functional groups R, e.g., by dipping, exhausting or any other suitable technique. The fabric is subsequently washed and dried to result in treated fabric 221′. Although charged fabric 211′ is depicted as having negative charges thereon for purposes of illustration, it can also be positively charged. Functionalized polyelectrolyte 205′ is oppositely charged from the charged fabric 211′. The functional groups R can comprise more than one type of functional group and are capable of imparting a performance enhancing property to the fabric. Polyelectrolyte 205′ adsorbs onto and attaches to the fabric at least in part by virtue of the electronic interactions between the charged surface of the fabric and the charged groups on polyelectrolyte 205′. Optionally, functionalized polyelectrolyte 205′ can be applied to charged fabric 211′ under conditions which allow covalent bonds to be formed with the fabric in addition to the electrostatic interactions.

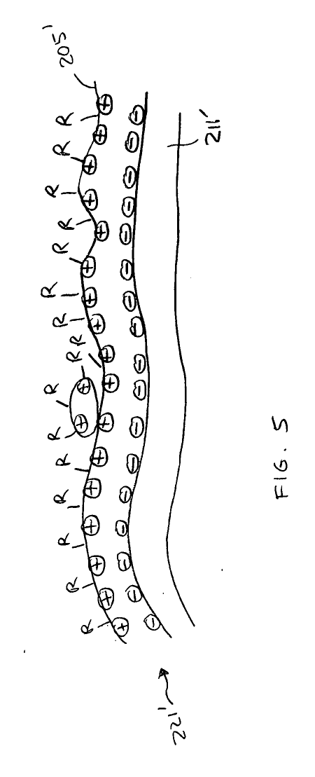

FIG. 5 shows a cross-sectional schematic of the treated fabric 221′. The polyelectrolyte 205′ is adsorbed onto and attached to charged fabric 211′ at least in part by virtue of electrostatic interactions between the oppositely charged surface of charged fabric 211′ and functionalized polyelectrolyte 205′. Functionalized polyelectrolyte 205′ contains functional groups R, which can comprise more than one type of functional group, that are capable of imparting performance enhancing properties to the treated fabric 221′.

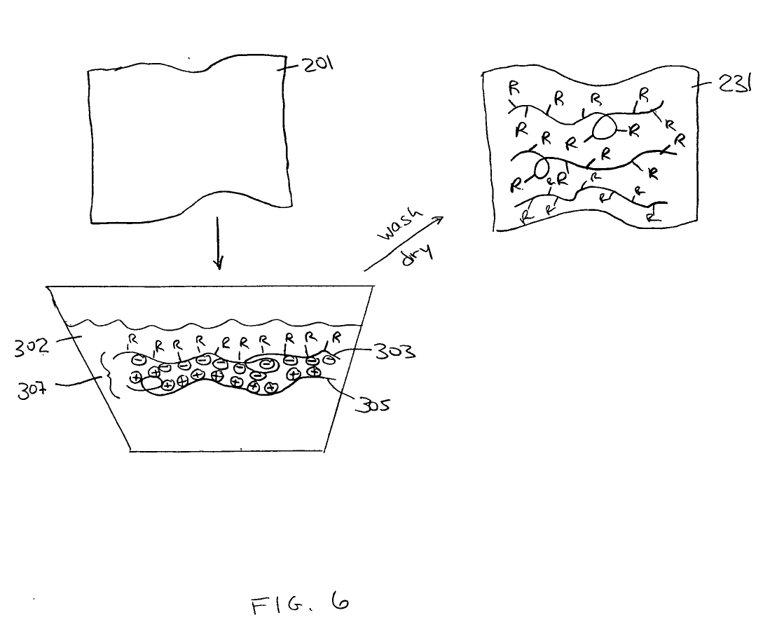

FIG. 6 shows a schematic of another method for treating a fabric described herein. A first polyelectrolyte 303 and a second polyelectrolyte 305 having opposite charge from the first polyelectrolyte are mixed in solution to form polyelectrolyte complex 307 that can separate from but does not precipitate out of solution 302. Fabric 201 is contacted with solution 302, e.g., by dipping, exhausting or any other suitable technique. The fabric is subsequently washed to remove residual solution 302 and dried to result in functionalized fabric 231. Although the negative polyelectrolyte 305 is depicted as having functional groups R for purposes of illustration, either or both polyelectrolytes 303 and 305 can have functional groups. In addition, the functional groups R can comprise more than one type of functional group. The functional groups are capable of imparting performance enhancing properties to the treated fabric 231. The polyelectrolyte complex 307 is adsorbed onto and attached to fabric 201. The complex can be attached to the fabric by non-covalent interactions, such as hydrogen bonding or van der Waals forces. Optionally, polyelectrolyte complex 307 can be applied to fabric 201 under conditions which allow covalent bonds to be formed between complex 307 and fabric 201, e.g., by including a curing step after application ofthe complex.

Although FIGS. 2-6 schematically depict ionic polymers 203, 205, 205′, 303, 305 as having charged moieties on the backbone and functional groups as side chains for purposes of illustration, it is also understood that charges can be on polymer side groups and functional groups can be part of the polymer backbones.

To impart hydrophobic properties to a fabric, the functionalized polyelectrolyte can comprise monomers having hydrocarbon chains or other hydrophobic moieties. The length, density and degree of branching of pendant hydrocarbon side chains can be chosen to impart desired hydrophobic properties to the surface of the fabric and to adjust solubility of the polyelectrolyte in solution for processing purposes, e.g., C6-C30 straight, branched, or cyclic alkyl groups. Examples of such monomers include N-(tert-buytl)acrylamide, n-decyl acrylamide, n-decyl methacrylate, n-dodecylmethacrylamide, 2-ethylhexyl acrylate, 1-hexadecyl methacrylate, N-(n-octadecyl) acrylamide, n-tert-octylacrylate, stearyl acrylate, stearyl methacrylate, vinyl laurate and vinyl stearate.

To impart hydrophobic and/or oleophobic properties to a fabric, the functionalized polyelectrolyte can comprise monomers having fluorocarbon groups. Application of fluorocarbon groups to the surface of a fabric can impart water and/or oil resistance, water and/or oil repellency, stain resistance and soil release properties to a fabric. Such fluorocarbon groups may comprise straight, branched, or cyclic fluorocarbons, including fully or partially fluorinated hydrocarbons, and may comprise straight, branched, or cyclic C1-C30 alkyl groups. The length, density, and degree of branching of pendant fluorinated or non-fluorinated side groups can be selected to impart desired solubility properties for processes as well as desired levels of hydrophobicity and oleophobicity. Particularly useful fluorinated monomers are acrylate and methacrylate monomers with the structures H₂C═CHCO₂CH₂ CH₂(CF₂)ₙF and H₂C═C(CH₃)CO₂CH₂CH₂(CF₂)ₙF, where n in both cases is 1 to 20, or between approximately 5 and 12. In addition, chain lengths that fall outside of these ranges may be useful, e.g., from commercially available monomers that contain a distribution of chain lengths. Examples of such monomers include 1 H, 1 H, 7 H-dodecafluoroheptyl methacrylate, 1 H, 1 H, 2 H, 2 H-heptadecafluorodecyl acrylate, 1 H, 1 H, 2 H, 2 H-heptadecafluorodecyl methacrylate, 1 H, 1 H-hexafluorobutyl acrylate, 1 H, 1 H-hexafluorobutyl methacrylate, hexafluoro-isopropyl acrylate, 1 H, 1 H-pentadecafluorooctyl acrylate, 1 H, 1 H-penatdecafluorooctyl methacrylate, 1 H, 1 H, 3 H-tetraflurorpropyl acrylate, 1 H, 1 H, 3 H-tetrafluoropropyl methacrylate, 2,2,2-trifluoroethyl acrylate, and 2,2,2-trifluorethyl methacrylate.

To impart hydrophilic properties to a fabric, the functionalized polyelectrolyte can comprise monomers including acrylamide, acrylic acid, N-acryloyltris(hydroxymethyl)methylamine, glycerol mono(meth)acrylate, 4-hydroxybutyl methacrylate, 2-hydroxyethyl acrylate, 2-hydroxyethyl methacrylate (glycol methacrylate), N-(2-hydroxypropyl)methacrylamide, N-methacryloyltris(hydroxymethyl)methamine, N-methylmethacrylamide, poly(ethylene glycol) monomethacrylate, poly(ethylene glycol) monomethyl ether monomethacrylate, 2-sulfoethyl methacrylate, and N-vinyl-2-pyrrolidone (1-vinyl-2-pyrrolidone). Fabrics treated to have hydrophilic properties can demonstrate antistatic behavior.

To impart flame retardancy properties to a fabric, a polyelectrolyte complex between a polyelectrolyte containing an amino group and a polyelectrolyte containing phosphorus can be applied to a fabric. In addition, a single polyelectrolyte containing an amino group and phosphorus can be used. N-P interactions can lead to a synergistic flame retardant effect. For example, a polycation containing a quatemized ammonium group and a polyanion containing phosphorus (e.g., phosphate) can be used to form a polyelectrolyte complex.

In addition, monomers can be included in a polyelectrolyte to be applied to a fabric that can impart anti-microbial properties, such as anti-bacterial or anti-fungal properties, to the fabric. Anti-microbial properties can be achieved by applying a polyelectrolyte or polyelectrolyte complex having excess positive charge to a fabric. The resulting fabric then has a cationic surface, which can have anti-microbial properties.

Wrinkle resistance and wrinkle recovery can by achieved using polyelectrolytes and polyelectrolyte complexes described herein. By applying polyelectrolytes or polyelectrolyte complexes that can ionically cross-link with fabrics, desired wrinkle resistance and wrinkle recovery properties can be imparted to the fabrics.

Thus, in some embodiments, referred to herein as the “two step process,” as illustrated in two variations in FIGS. 2 and 4, a durable coating including a functionalized polyelectrolyte can be applied to a surface of a fabric using two primary steps. The functionalized polyelectrolyte has functional groups capable of imparting a performance enhancing property to the fabric. In the first step, a surface of the fabric 201 is modified, i.e., charged, by disposing ions or ionizable groups of the same charge on the surface. As shown in FIG. 2, the surface can be modified to have a charge by treating the fabric with a surface modifying ionic polymer 203. The surface modifying ionic polymer can be applied by any appropriate method, such as padding, dipping, and the like. The surface modifying ionic polymer is adsorbed onto the surface of the fabric and may be attached to the fabric through non-covalent interactions, such as hydrogen bonding or van der Waals interactions. Optionally, the surface modifying ionic polymer can be applied under conditions that allow covalent bond formation between the polymer and the fabric, e.g., by the use of reactive groups on either or both the polymer and the fabric surface, or by the use of a curing step. Alternatively, as illustrated schematically in FIG. 4, a surface of fabric 201 can be modified to bear charges, i.e., form charged fabric 211′, by introducing charged groups such as carboxylate, sulfonate, phosphate groups, or quaternized ammonium onto the fabric surface, or by plasma treating the fabric. Examples of fabric surface modification to form a negatively charged fabric 211′ include but are not limited to caustic denier reduction (alkaline hydrolysis), aminolysis, and other functional modification.

In a second step of the “two step process,” as illustrated in the variations schematically depicted in FIGS. 2 and 4, the surface modified fabric 211 or 211′ having a first charge is treated with a functionalized ionic polymer 205 or 205′ having a charge opposite the first charge. The functionalized ionic polymer 205 or 205′ may be applied from solution 202 or 204′, respectively, by any suitable technique, e.g., by padding or by exhausting (e.g., via dyeing machines) onto the fabric. The functionalized ionic polymer 205 or 205′ includes a functional group capable of imparting a performance-enhancing property to the fabric. The functionalized ionic polymer adsorbs onto and interacts with the modified surface of the fabric 211 or 211′ at least in part through electrostatic interactions.

In other embodiments, the fabric is treated in one step (the “one-step process”), illustrated schematically in FIG. 6. A bath 302 is provided containing a polyelectrolyte complex 307 comprising both an anionic polymer 303 and a cationic polymer 305. One or both of the cationic and anionic polymers 303, 305 has functional groups capable of imparting a performance enhancing property to the treated fabric. This polyelectrolyte complex 307 is stable and may separate from the solution but generally does not precipitate out of solution. The polyelectrolyte complex 307 is applied to the surface of the fabric 201 to form treated fabric 211′. Polyelectrolyte complex 307 is adsorbed onto the surface of the fabric and can be attached to the fabric via non-covalent interactions such as hydrogen bonding or van der Waals forces. Alternatively, the complex 307 can be applied to the surface of the fabric under conditions in which the complex can be covalently bonded to the fabric, e.g., by providing reactive groups on either or both the fabric surface and the polyelectrolyte complex or by use of a curing process.

With both the one-step and the two-step processes, the treated fabric 211, 211′, or 311, is dried to durably fix the performance enhancing finish to the fiber or fabric. Optionally, a curing step can follow the final drying step. Wetting agents or surfactants that can lower the fabric surface tension may be used to facilitate application of an ionic polymer or a polyelectrolyte complex to the fabric. By “durably fix” or “durable,” it is meant that the performance enhancing property of the treated fabrics described herein persist after cleaning, e.g., for at least about 10 home launderings, or at least about 25 home launderings, or at least 30 home launderings, or at least 40 home launderings, or for at least about 50 home launderings. In some cases, the treatment can be permanent; that is, the performance enhancing characteristics persist for the life of the treated fabric. By “persist,” it is meant that the performance enhancing properties may change from an initial level, but remain above a minimum acceptable level after the specified number of home launderings.

In some variations, cationic polymer useful for the coatings, methods, and fabrics described herein have a positive charge density greater than 1 meq/g. Particularly useful charge densities are 4.0 meq/g or higher, 6.0 meq/g or higher, or 8.0 meq/g or higher. When used in the two-step process described above, the cationic polymers have a high molecular weight, e.g., from about 10,000 to about 1,000,000 Dalton, or from about 10,000 to about 100,000, or from about 100,000 to about 300,000, or from about 300,000 to about 500,000, or from about 500,000 to about 700,000, or from about 700,000 to about 1,000,000. When used in the one-step process described above, the cationic polymers can have lower molecular weights, e.g., from about 1000 to about 100,000 Dalton, or from about 1,000 to about 3,000, or from about 3,000 to about 5,000, or from about 5,000 to about 10,000, or from about 10,000 to about 20,000, or from about 20,000 to about 40,000, or from about 40,000 to about 60,000, or from about 60,000 to about 80,000, or from about 80,000 to about 100,000. Monomers of these cationic polymers include but are not limited to: 2-aminoethyl methacrylate hydrochloride, N-(3-aminopropyl)methacrylamide hydrochloride, 4,4′-diamino-3,3′-dinitrodiphenyl ether, 3,3′-diaminodiphenyl sulfone, 2-(tert-butylamino)ethyl methacrylate, diallylamine, 2-(iso-propylamino)ethylstyrene, ethylene imine, 2-(N,N-diethylamino)ethylmethacrylate, 2-(diethylamino)ethylstyrene, 2-(N,N-dimethylamino)ethyl acrylate, N-[2-(N,N-dimethylamino)ethyl]methacrylamide, 2-(N,N-dimethylamino)ethyl methacrylate, N-[3-(N,N-dimethylamino)propyl]acrylamide, N-[3-(N,N-dimethylamino) propyl]-methacrylamide, 2-vinylpyridine, 4-vinylpyridine, 2-acryloxyethyltrimethylammonium chloride, diallyldimethylammonium chloride, 2-methacryloxyethyltrimethylammonium chloride, polyethyleneimine, ionenes, polyamide-polyamine-epichlorohydrin, and polyhexamethylene biguanide. The cationic polymers may be branched, e.g., from about 0.001% to about 10% branched. In particular, examples of cationic polymers that may be used for the coatings described herein include polyquaternium-16, with molecular weight of approximately 40,000 and a charge density of 6.1 meq/g, polyquaternium-1, polyquaternium-4, polyquaternium-5, polyquaternium-7, polyquaternium-10, polyquaternium-11, polyquaternium-22, and poly(diallyidimethylammonium chloride) (PDADMAC), with molecular weight of 100,000-500,000 and charge density of 6.2 meq/g.

In some variations, anionic polymers useful for the coatings, methods, and fabrics described herein have a high negative charge density (>1 meq/g). In some variations, the anionic polymer will have a negative charge density of 4.0 meq/g or higher, or 6.0 meq/g or higher, or 8.0 meq/g or higher, or 10.0 meq/g or higher. When used in the two-step process described above, the anionic polymer will preferably have a high molecular weight, e.g., from 100,000 to 1,000,000 Dalton, or from about 100,000 to about 300,000, or from about 300,000 to about 500,000, or from about 500,000 to about 800,000 or from about 800,000 to about 1,000,000. When used in the one-step process described above, the anionic polymer will have a lower molecular weight, e.g., from 1,000 to 100,000 Dalton, e.g., from about 1,000 to about 3,000, or from about 3,000 to about 5,000, or from about 5,000 to about 10,000, or from about 10,000 to about 20,000, or from about 20,000 to about 40,000, or from about 40,000 to about 60,000, or from about 60,000 to about 80,000, or from about 80,000 to about 100,000. Without being bound by theory, it is believed that the lower molecular weight anionic polymer allows some suspendability in aqueous solution which stabilizes the polyelectrolyte complex of the anionic and cationic polymers.

In some variations, anionic polymers that may be used for the coatings, methods, and fabrics described herein include those that contain carboxyl, carboxylate, or carboxyl precursor groups, which are referred to herein as “carboxyl-containing polymers” or “polycarboxylates”. The carboxyl-containing polymers can be obtained through polymerization or copolymerization of one or more monomers that contain a carboxyl group, a carboxylate, or a group that can become a carboxyl or carboxylate group through a chemical reaction (a carboxyl precursor group). Non-limiting examples of such monomers include: acrylic acid, methacrylic acid, aspartic acid, glutamic acid, β-carboxyethyl acrylate, maleic acid, monoesters of maleic acid [ROC(O)CH═CHC(O)OH, where R represents an alkyl group, or a perfluoroalklyl group], maleic anhydride, fumaric acid, monoesters of fumaric acid [ROC(O)CH═CHC(O)OH, where R represents an alkyl group or perfluoroalkyl group], acrylic anhydride, crotonic acid, cinnamic acid, itaconic acid, itaconic anhydride, monoesters of itaconic acid [ROC(O)CH₂(═CH₂)C(O)OH, where R represents an alkyl group or a perfluoroalklyl group], saccharides with carboxyl (e.g., alginic acid), carboxylate, or carboxyl precursor groups, and macromonomers that contain carboxyl, carboxylate, or carboxyl precursor groups. Carboxyl precursors include, but are not limited to, acid chlorides, N-hydroxysuccinimidyl esters, amides, esters, nitriles, and anhydrides. Examples of monomers with carboxyl precursor groups include (meth)acrylate chloride, (meth)acrylamide, N-hydroxysuccinim ide (meth)acrylate, (meth)acrylonitri le, asparigine, and glutamine. Herein the designation “(meth)acryl” indicates both the acryl- and methacryl-versions of the monomer. Carboxylate cations can include aluminum, barium, chromium, copper, iron, lead, nickel, silver, strontium, zinc, zirconium, and phosphonium (R₄P⁺, where R represents an alkyl or perfluoroalkyl group), hydrogen, lithium, sodium, potassium, rubidium, ammonium, calcium, and magnesium. The anionic polymers may be linear or branched. The anionic polymers can be branched, for example, by having about 0.001% and about 10% branching, inclusive.

If polymers that contain carboxyl precursor groups are used as the carboxyl-containing anionic polymer, the precursors must be hydrolyzed to form carboxyl groups either during or after application of the functionalized polyelectrolyte to the fabric. Conditions for hydrolysis depend on the nature of the precursors. In some situations, the hydrolysis can occur under similar pH and temperature conditions to those at which the fabric is being treated, which can facilitate formation of the carboxyl groups as the functionalized ionic polymer is being applied to the fabric. Examples of precursor groups include acid chlorides and anhydrides. Other precursor groups may require acidic or basic aqueous conditions and elevated temperatures for hydrolysis; such groups include esters and amides.

In applying the carboxyl-containing anionic polymer in the two-step process to a fabric, the process temperature can vary widely, depending on the reactivity of the reactants. However, the temperature should not be so high as to decompose the reactants or so low as to cause inhibition of the reaction or freezing of the solvent. Unless specified to the contrary, the fabric is contacted with the polymers at atmospheric pressure over a temperature range between about 5° C. and about 110° C., between about 15° C. and about 60° C., or at room temperature, approximately 20° C. The pH at which the anionic polymer is applied may be below pH 7, such as between about pH 1 to about pH 5, or between about pH 2 to about pH 4.5. The time required for the processes herein will depend to a large extent on the temperature being used and the relative reactivities of the starting materials. Unless otherwise specified, the process times and conditions are intended to be approximate. When a curing step is used, curing conditions may range from about 5° C. to about 250° C., or between about 150° C. and about 200° C.

Other anionic polymers bearing high negative charge density, such as sulfonate and phosphate containing polymers, can be applied to the fabric by any suitable technique, e.g., by padding or exhaustion. Examples include poly(styrene sulfonate), molecular weight about 1 million, charge density of 4.9 meq/g, sulfonated polyester fiber, poly(vinyl sulfonate), taurine, and aspartic acid. Surface modification using hydrolysis (alkaline or amino acids) is typically done in dyeing machines over a temperature range between 20° C. and 120° C., or between 40° C. and 100° C., or between 60° C. and 90° C.

The ionic polymers can be applied to fabrics by any suitable technique, such as by exhaustion, e.g., in a dyeing machine, in continuous or batch mode, or by padding, by spray coating, or by adding in during the laundry process. Formulations ofthe ionic polymers can be adjusted as appropriate for the application method being used.

To prepare a fabric having antistatic properties, the fabric is contacted with a solution that contains a cationic polymer, such that the cationic polymer coats at least a portion of a surface of the fabric. The fabric can be exposed to the solution by any applicable method, such as exhaustion, padding, dipping, and the like. Without being bound by theory, it is believed that antistatic properties of the treated fabric result from an ionic conduction mechanism. Both cationic polymers and anionic polymers have small mobile counter ions. Cationic polymers having a hygroscopic nature, e.g., through hygroscopic functional groups which help to form or retain water on the textile surface, can increase the mobility of these ions to dissipate static electrical charges. To maximize the durability of the cationic coating, i.e., to improve the wash-fastness of the fabric and retain satisfactory antistatic performance after laundering, the surface of the fabric can be modified to make it bear negative charges prior to or simultaneously with the application of the cationic polymer such that the cationic polymer can interact with or complex with the charged surface of the fabric, at least in part by virtue of the electrostatic interactions between the oppositely charged surface and polycation.

### EXAMPLES

The following non-limiting examples are provided to allow further understanding of the compositions and methods for treating fabrics described herein

General Information:

Standard home launderings are done based on AATCC method 124-2001, last modified in 2001, substituting 28 grams of granular Tide® detergent (Proctor & Gamble) for the 66 grams of 1993 AATCC standard reference detergent. To conduct a home laundering, a square piece of fabric (approximately 8″×8″) was placed in a standard home washing machine. The samples were washed with warm water on the “normal” wash and spin cycles. The samples were tumble dried as stated in the standard AATC method 124-2001.

One performance target is to make synthetic fabrics, such as polyester and nylon fabrics, have the same or better antistatic properties (surface resistivity, cling time, and static decay) as 100% cotton fabrics. Antistatic performance can be measured by industrial standard, set forth in Table A below (from Chemical Finishing of Textiles, Wolfgang D. Schindler and Peter J. Hauser, 2004, Woodhead Publishing, Limited). A surface resistivity of greater than 5×10¹¹ ohm/square is considered inadequate although surface resistivities that differ from these values may be consumer relevant and desirable.

TABLE A
Industrial anti-static performance classification
(65% relative humidity, 20° C.)

| Surface resistivity (ohm/square) | Anti-static Grade |
|---|---|
| 1.00 × 10⁷-1.00 × 10⁹ | Very Good |
| 1.00 × 10⁹-1.00 × 10¹⁰ | Good |
| 1.00 × 10¹⁰-1.00 × 10¹¹ | Satisfactory |

| | |
|---|---|
| 1.00 × 10¹¹-5.00 × 10¹¹ | Sufficient |
| >5.00 × 10¹¹ | Inadequate |

### Example 1

Swatches of polyester fabric (plain woven, 6 oz/yd²) were treated with poly(acrylic acid) (PAA) as follows: Each fabric sample was dipped into an aqueous solution containing 20 wt. % PAA (average molecular weight 1,000,000, pH 3.3-3.9) and 0.1 wt. % WetAid™ wetting agent, and was padded to a wet pick-up of approximately 100%. The samples were dried at 250° F. for 5 minutes, then cured at 320° F. for 30 seconds, after which they were washed and dried.

In a second step, an aqueous solution of 1% to 10% (by weight) cationic polymer polyquaternium-16 (molecular weight about 40,000) was applied to the PAA-treated fabric. Polyquaternium-16 solution was padded with a 60% to 100% wet pick-up onto a PAA-treated polyester swatch. The sample was then dried and conditioned at 60% relative humidity and 70° F. for at least 4 hours before testing. The surface resistivity of the polyester swatch measured at 60% relative humidity (RH), 70° F. was rated “sufficient” after 5 home launderings.

### Example 2

PAA-treated polyester fabric prepared as in Example 1 was dipped into a 3-5 wt. % aqueous solution of PDADMAC (molecular weight 400,000-500,000) and padded to 90-100% wet pick-up. The fabric was then dried at 300° F. for 30 seconds. Surface resistivity as a function of number of home launderings is reported in Table B below.

### Example 3

PAA-treated polyester fabric prepared as in Example 1 was dipped into a 2-3 wt. % aqueous solution of Polyquaternium-16 (molecular weight about 40,000) and padded to 90-100% wet pick-up. The fabric was then dried at 300° F. for 30 seconds. Surface resistivity as a function of number of home launderings is reported in Table B below.

### Example 4

A 3-5% aqueous solution of PDADMAC (molecular weight 400,000-500,000) (liquor ratio 10:1) was exhausted onto anionically-modified PAA-treated polyester fabric prepared according to the process of Example 1 in a dyeing machine for 15-30 minutes at 40°-60° C. Samples were then rinsed, dried and conditioned at 60% relative humidity and 70° F. for at least 4 hours before testing. Surface resistivity is reported as a function of number of home launderings is provided in Table B below.

### Example 5

A 2-3% aqueous solution of polyquaternium-16 (molecular weight 40,000) (liquor ratio 10:1) was exhausted onto anionically-modified PAA-treated polyester fabric prepared according to the process of Example 1 in a dyeing machine for 15-30 minutes at 40°-60° C. Samples were then rinsed, dried and conditioned at 60% relative humidity and 70° F. before testing. Surface resistivity as a function of number of home launderings is provided in Table B below.

### Example 6

Polyester fabric samples (plain woven, 6 oz/yd²) were treated in a one-step process by padding, as follows: 6% (by weight) cationic polymer, PDADMAC (molecular weight 400,000-500,000), was dissolved in water, after which 4% (by weight) NaCl and 1% (by weight) anionic polymer (PAA, molecular weight approximately 1,000-10,000) were added, with stirring to form a polyelectrolyte complex. Additionally, 0.2% (by weight) cetyltrimethylammonium chloride (CTAC) was added to the solution as a surfactant. The fabric was dipped in the prepared solution of polyelectrolyte complex and padded to 100% wet pick-up. It was then dried and cured at 380° F. for 30 seconds. Surface resistivity as a function of number of home launderings is provided in Table B below.

### Example 7

Polyester fabric samples (plain woven, 6 oz/yd²) were treated in a one-step application by exhaustion, as follows: 0.5% to 1% (by weight) of cationic polymer, PDADMAC (molecular weight 400,000-500,000) was dissolved in water (5:1 to 20:1 liquor ratio), after which 0.2% to 6% (by weight) anionic polymer (PAA, having molecular weight of approximately 1,000-100,000) were added, with stirring. The prepared solution of polyelectrolyte complex was exhausted onto fabric at 30° C. to 100° C. for 10 minutes to 30 minutes. Samples were dried at 250° F. for 5 minutes. Surface resistivity as a function of number of home launderings is provided in Table B below.

### Example 8

Polyester fabric samples (plain woven, 6 oz/yd²) were treated in a one-step application by alternatively depositing cationic polymer and anionic polymer layers on substrates in a dyeing machine. Liquor ratios are from 5:1 to 20:1 and all weights were based on goods. Exhaustion temperature range is from 30° C. to 100° C. A total of 0.5% to 10% (by weight) of polyquaternium-16 (molecular weight about 40,000) was dissolved in water. The same procedure was applied to make an aqueous solution of 0.1% to 6% (by weight) anionic polymer (PAA, molecular weight less than 1,000,000). The solution of the cationic polymer then was added into the dyeing machine alternatively with the solution of the anionic polymer to be exhausted onto the fabric in multiple portions. The total process took about 30 to 60 minutes. After the exhaustion, all samples were rinsed, dried at 250° F. for 5 minutes, and conditioned at 60% relative humidity, 70° F., before testing. Surface resistivity as a function of number of home launderings is provided in Table B below.

Surface Resistivity Data

Surface resistivities (ohm/sq) of 100% polyester (woven, 6 oz/yd²) samples treated as described in Examples 2 to 8, along with 100% cotton and untreated polyester samples, are listed in Table B, as a function of number of home launderings (HL).

TABLE B
Surface resistivity of treated and untreated samples (60% relative humidity, 20° C.), measured in ohm/sq.

| Fabric Type | 0 HL | 1 HL | 5 HL | 10 HL | 20 HL | 30 HL |
|---|---|---|---|---|---|---|
| 100% woven | 2.22 × 10¹⁰ | 6.37 × 10¹⁰ | 1.73 × 10¹¹ | 1.49 × 10¹¹ | 2.18 × 10¹¹ | 2.20 × 10¹¹ |
| cotton, 4 oz/yd² | | | | | | |
| 100% woven | 1.10 × 10¹⁰ | 3.22 × 10¹⁰ | 1.14 × 10¹¹ | 7.17 × 10¹⁰ | 1.27 × 10¹¹ | 1.02 × 10¹¹ |
| cotton, 8 oz/yd² | | | | | | |
| 100% untreated | >2.00 × 10¹² | >2.00 × 10¹² | >2.00 × 10¹² | >2.00 × 10¹² | >2.00 × 10¹² | >2.00 × 10¹² |
| woven polyester | | | | | | |
| 6 oz/yd² | | | | | | |
| Example 2 | 4.87 × 10⁷ | 3.82 × 10¹⁰ | 2.32 × 10¹⁰ | 2.78 × 10¹⁰ | 1.53 × 10¹⁰ | 2.21 × 10¹⁰ |
| Example 3 | 1.29 × 10⁸ | 7.83 × 10¹⁰ | 2.53 × 10¹⁰ | 3.69 × 10¹⁰ | 6.45 × 10¹⁰ | 4.47 × 10¹⁰ |
| Example 4 | 1.26 × 10¹⁰ | 3.15 × 10¹⁰ | 1.71 × 10¹⁰ | 1.87 × 10¹⁰ | 2.43 × 10¹⁰ | 1.46 × 10¹⁰ |
| Example 5 | 4.32 × 10¹⁰ | 6.19 × 10¹⁰ | 4.35 × 10¹⁰ | 4.73 × 10¹⁰ | 6.93 × 10¹⁰ | 7.53 × 10¹⁰ |
| Example 6 | 2.87 × 10⁷ | 7.32 × 10¹⁰ | 2.15 × 10¹⁰ | 7.44 × 10¹⁰ | 1.61 × 10¹⁰ | 5.51 × 10¹⁰ |
| Example 7 | 1.92 × 10¹⁰ | 1.46 × 10¹⁰ | — | 5.20 × 10⁹ | 3.03 × 10⁹ | 7.04 × 10⁹ |
| Example 8 | 3.00 × 10¹⁰ | 6.92 × 10⁹ | 2.81 × 10⁹ | 3.02 × 10⁹ | 1.08 × 10¹⁰ | 1.07 × 10¹⁰ |

Although the foregoing compositions, methods and fabrics, have been described in some detail by way of illustration and example for purposes of clarity of understanding, it is apparent to those skilled in the art that certain minor changes and modifications will be practiced. Therefore, the description and examples should not be construed as limiting the scope of the invention.

What is claimed is:

1. A composition for imparting a performance enhancing property to a fabric comprising a complex between an anionic polymer and a cationic polymer, wherein either the anionic polymer or the cationic polymer comprises a functional group that is capable of imparting the performance enhancing property to the fabric.

2. The composition of claim 1, wherein the complex is formed by first attaching one of the anionic polymer and the cationic polymer to at least a portion of a surface of the fabric and subsequently applying the other of the anionic polymer and the cationic polymer to the fabric, wherein the last to be applied of the anionic polymer and the cationic polymer comprises the functional group.

3. The composition of claim 1, wherein the complex is formed by first combining the cationic polymer and the anionic polymer in solution.

4. The composition of claim 1, wherein the performance enhancing property is selected from the group consisting of water-repellence, oil-repellence, stain-resistance, wrinkle-resistance, antistatic behavior, soil release behavior, hydrophobicity, hydrophilicity, antimicrobial, flame retardancy, thermal regulation and UV resistance.

5. The composition of claim 1, wherein the functional group comprises a fluorocarbon.

6. The composition of claim 1, wherein the cationic polymer and anionic polymers each have a charge density greater than 1 meq/g.

7. The composition of claim 6, wherein the anionic polymer comprises carboxyl, carboxylate, carboxyl precursor groups, sulfonate, sulfate, or phosphate groups.

8. The composition of claim 6, wherein:
the cationic polymer comprises poly(diallyldimethylammonium chloride) or a polyquaternium polymer;
the anionic polymer comprises polyacrylic acid; and
the performance enhancing property comprises antistatic behavior.

9. The composition of claim 1, wherein the cationic polymer comprises a monomer selected from a group consisting of: 2-aminoethyl methacrylate hydrochloride, N-(3-aminopropyl)methacrylamide hydrochloride, 4,4′-diamino-3,3′-dinitrodiphenyl ether, 3,3′-diaminophenyl sulfone, 2-(tert-butylamino)ethyl methacrylate, diallylamine, 2-(isopropylamino) ethylstyrene, ethylene imine, 2-(N,N-diethylamino)ethyl methacrylate, 2-(diethylamino)ethylstyrene, 2-(N,N-dimethylamino)ethyl acrylate, N-[2-(N,N-dimethylamino) ethyl]methyacrylamide, 2-(N,N-dimethylamino)ethyl methacrylate, N-[3-(N,N-dimethylamino) propyl]acrylamide, N-[3-(N,N-dimethylamino)propyl]-methacrylamide, 2-vinylpyridine, 4-vinylpyridine, 2-acryloxyethytrimethylammonium chloride, diallydimethylammonium chloride, and 2-methacryloxyethyltrimethylammonium chloride.

10. A method of treating a fabric, comprising:
a) modifying a surface of the fabric to impart a performance enhancing property thereto by providing ions or ionizable compounds on at least a portion of the surface, the ions or ionizable compounds having a first charge; and
b) applying a first ionic polymer to the fabric, wherein:
the first ionic polymer has a charge opposite the first charge;
at least a portion of the first ionic polymer interacts with the ions or ionizable compounds of the modified surface; and
the first ionic polymer comprises a functional group capable of imparting the performance-enhancing property to the fabric.

11. The method of claim 10, wherein the modification of the surface of the fabric by providing ions or ionizable compounds on at least a portion of the surface comprises applying a second ionic polymer having the first charge to the fabric.

12. The method of claim 10, wherein the performance enhancing property is selected from the group consisting of water-repellency, oil-repellency, stain-resistance, wrinkle-resistance, antistatic behavior, soil release behavior, hydrophobicity, hydrophilicity, antimicrobial behavior, flame retardancy, thermal regulation, UV resistance, and combinations thereof.

13. The method of claim 10, wherein:
the first charge is negative and the first ionic polymer comprises a cationic polymer having a charge density greater than 1 meq/g; and
the performance enhancing property comprises antistatic behavior.

14. The method of claim 10, wherein the functional group comprises a fluorocarbon.

15. The method of claim 10, wherein:
the first charge is positive;
the first ionic polymer comprises an anionic fluoropolymer; and
the performance enhancing property comprises water-repellency, oil-repellency, or hydrophobicity.

16. The method of claim 11, wherein the application of the second ionic polymer to the fabric causes formation of non-covalent interactions between the second ionic polymer and the fabric.

17. The method of claim 11, wherein the conditions under which the second ionic polymer is applied to the fabric causes formation of covalent bonds between the second ionic polymer and the fabric.

18. The method of claim 11, wherein:
the first ionic polymer comprises a cationic polymer having a positive charge density greater than 1 meq/g; and
the second ionic polymer comprises an anionic polymer having a negative charge density greater than 1 meq/g.

19. The method of claim 18, wherein the first ionic polymer comprises poly(diallyldimethylammonium chloride) or a polyquaternium polymer, the second ionic polymer comprises polyacrylic acid, polycarboxylic acid, polycarboxylate, polysulfonic acid or polysulfonate, and the performance enhancing property comprises antistatic behavior.

20. A method of treating a fabric, comprising applying a complex between a cationic polymer and an anionic polymer to a surface of the fabric, wherein one of the cationic polymer and the anionic polymer comprises a functional group capable of imparting the performance enhancing property to the fabric.

21. A fabric having a performance enhancing property, wherein:
the performance enhancing property is selected from the group consisting of water repellency, oil repellency, stain resistance, antistatic behavior, soil release behavior, wrinkle resistance, hydrophobicity, hydrophilicity antimicrobial behavior, flame retardancy, thermal regulation, UV resistance and combinations thereof; and
the fabric has a coating disposed on at least a portion thereof, wherein the coating comprises an ionic polymer having a functional group capable of imparting the performance enhancing property to the fabric.

22. The fabric of claim 21, wherein:
the coating comprises a complex between a cationic polymer and an anionic polymer; and
one of the cationic polymer and the anionic polymer comprises the functional group.

23. The fabric of claim 21, wherein the ionic polymer comprises a charge density of greater than 1 meq/g.

24. The fabric of claim 22, wherein each of the cationic polymer and the anionic polymer has a charge density of greater than 1 meq/g.

25. The fabric of claim 24, wherein the cationic polymer comprises a polyquaternium polymer, the anionic polymer comprises polyacrylic acid, and the performance enhancing property comprises antistatic behavior.

26. The fabric of claim 21, wherein the performance enhancing property persists after 25 home launderings of the fabric.

27. The fabric of claim 21, wherein the performance enhancing property persists after 50 home launderings of the fabric.

28. The fabric of claim 21 adapted for use in garments, footwear, bedding, draperies, curtains, upholstery, outdoor fabrics, carpets, rugs, non-woven fabrics, automotive interiors, or technical textiles.

29. A kit for treating a fabric comprising:
an anionic polymer and a cationic polymer, wherein either the anionic polymer or the cationic polymer comprises a functional group that is capable of imparting a performance enhancing property to the fabric; and
instructions for applying the polymers to the fabric.
